(19) United States
(12) Patent Application Publication
(10) Pub. No.: US 2006/0021637 A1
(43) Pub. Date: Feb. 2, 2006

(54) Sump assembly in dishwasher

(75) Inventor: Myung Ho Kang, Busan (KR)

Correspondence Address: FLESHNER & KIM, LLP, P.O. BOX 221200, CHANTILLY, VA, 20153, US

(73) Assignee: LG Electronics Inc.

(21) Appl. No.: 10/990,428

(22) Filed: Nov. 18, 2004

(30) Foreign Application Priority Data
Jul. 28, 2004 (KR) P2004-0059027

(51) Int. Cl. B08B 3/00; B08B 3/04

(52) U.S. Cl. 134/56 D; 134/104.2; 134/172

(57) ABSTRACT

Sump assembly in a dishwasher including a sump for holding washing water, a washing pump on one side of the sump for pumping up the washing water from the sump to spray nozzles, a drain pump on the other side of the sump for discharging dirty washing water to an outside of the dishwasher, a drain hose connected to the drain pump for guiding the washing water to the outside of the dishwasher, and a sensor mounted on an inside of the drain pump for measuring a turbidity level of the washing water discharged to the outside of the dishwasher, thereby measuring the turbidity level of the washing water accurately, to enable effective operation of the dishwasher.

### CROSS-REFERENCE TO RELATED APPLICATIONS

This application claims the benefit of Korean Application No. P2004-059027, filed on Jul. 28, 2004, which is hereby incorporated by reference as if fully set forth herein.

### BACKGROUND OF THE INVENTION

1. Field of the Invention

The present invention relates to dishwashers, and more particularly, to a sump assembly in a dishwasher, in which a turbidity level of washing water is measured accurately, to enable an effective operation of the dishwasher.

2. Discussion of the Related Art

The dishwasher washes and dries dishes automatically by spraying detergent and washing water to the dishes.

In general, the dishwasher is provided with a rack for placing the dishes thereon, and a sump for holding the washing water, and spray nozzles for spraying the washing water toward the dishes, and a motor for supplying the washing water from the sump to the spray nozzles.

The operation of the dishwasher will be described briefly.

Upon putting the motor into operation, to supply the washing water from the sump to the spray nozzles, the spray nozzles spray the washing water to the dishes, to wash the dishes. The sprayed washing water returns to the sump, and sprayed to the dishes again.

Upon repeating above steps, the washing water is contaminated gradually, lifting the turbidity level, and if heavily contaminated washing water is used, not only washing performance becomes poor, but also a flow passage of the washing water is liable to be clogged.

In order to prevent this, the washing water is replaced periodically. That is, if the dish washing steps are repeated more than preset times, or period, the washing water held in the sump is discharged to an outside of the dishwasher, and fresh washing water is introduced into the dishwasher.

The replacement of the washing water is preformed as the user selects an appropriate operation mode of the dishwasher according to a contamination level of the dishes. That is, depending on determination of the user, a washing time period and a number of washing water replacement are fixed.

However, since the related art dishwasher repeats the step of replacement of the washing water according to the operation mode selected by the user without an accurate measurement of the turbidity level of the washing water, there have been problems in that dish washing is not performed adequately, or the washing water is wasted, unnecessarily.

That is, in a case the user fails to select a proper operation mode, the washing water can be wasted as washing water replacement is made unnecessarily, or the dish washing is perfect due to inadequate washing water replacement.

### SUMMARY OF THE INVENTION

Accordingly, the present invention is directed to a sump assembly in a dishwasher that substantially obviates one or more problems due to limitations and disadvantages of the related art.

An object of the present invention is to provide a sump assembly in a dishwasher, in which a turbidity level of washing water is measured, for effective operation of the dishwasher.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a sump assembly in a dishwasher includes a sump for holding washing water, a washing pump on one side of the sump for pumping up the washing water from the sump to spray nozzles, a drain pump on the other side of the sump for discharging dirty washing water to an outside of the dishwasher, a drain hose connected to the drain pump for guiding the washing water to the outside of the dishwasher, and a sensor mounted on an inside of the drain pump for measuring a turbidity level of the washing water discharged to the outside of the dishwasher.

The sensor may be provided to an inlet of the drain pump the washing water is introduced therethrough, or to an outlet of the drain pump the washing water is guided to the drain hose therethrough.

The sensor is a photocoupler having a light emitting part and a light receiving part.

It is preferable that the sensor is provided to an inside of the sump additionally, for measuring the turbidity level of the washing water. The sensor is a photocoupler having a light emitting part and a light receiving part.

The drain pump includes a pump case for holding the washing water from the sump, an impeller for pumping the washing water to the drain hose, and a hose connector for connection to the drain hose.

The sensor may be provided to an inside surface of the pump case, or to an inside surface of the hose connector.

In another aspect of the present invention, a dishwasher includes a washing chamber for making dish washing therein, spray nozzles for spraying high pressure washing water to dishes inside of the washing chamber, a sump for holding washing water, a washing pump on one side of the sump for pumping up the washing water from the sump to spray nozzles, a drain pump on the other side of the sump for discharging dirty washing water to an outside of the dishwasher, a drain hose connected to the drain pump for guiding the washing water to the outside of the dishwasher, and a sensor mounted on an inside of the drain pump for measuring a turbidity level of the washing water discharged to the outside of the dishwasher.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a section of a dishwasher in accordance with a preferred embodiment of the present invention;

FIG. 2 illustrates a perspective disassembled view of a sum assembly in accordance with a preferred embodiment of the present invention; and

FIG. 3 illustrates a perspective view of a drain pump in accordance with a preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

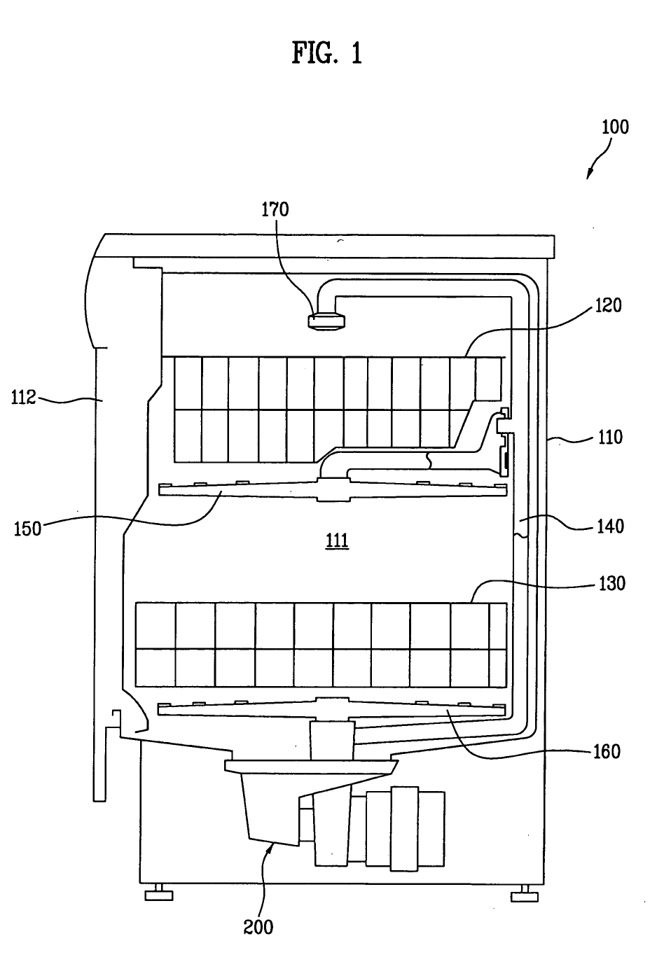

FIG. 1 illustrates a section of a dishwasher in accordance with a preferred embodiment of the present invention.

Referring to FIG. 1, the dishwasher 100 includes a cabinet 110 forming an outer appearance, racks for placing dishes thereon, spray nozzles for spraying washing water to the dishes, and a sump assembly 200.

The cabinet 110 has a washing chamber 111 therein for washing the dishes, and a door 112 in a front thereof for closing the washing chamber 111.

The racks have an upper rack 120 and a lower rack 130 in upper and lower portions of the washing chamber 111 each supported on a rail (not shown) in the cabinet 110 movable in front/rear directions.

The spray nozzle includes an upper nozzle 150 and a lower nozzle 160 adjacent to respective racks, and a top nozzle 170.

The upper nozzle 150, and the lower nozzle 160 are rotatably mounted under the upper rack 120 and the lower rack 130 respectively, for spraying high pressure washing water toward the dishes on the upper, and lower racks 120, and 130, respectively. For this, the upper, and lower nozzles 150, and 160 are provided with a plurality of spray holes in upper surfaces thereof for ejecting the washing water. The top nozzle 170 is mounted at a top of the washing chamber 111, for ejecting the washing water downward vertically, to wash the dishes.

The sump assembly 200 in a lower portion of the dishwasher 100 holds the washing water supplied from an outside of the dishwasher. The sump assembly 200 pumps up the washing water to the spray nozzles. For this, the sump assembly 200 is connected to the lower nozzle 160, as well as the upper nozzle 150 and the top nozzle 170 through a water supply pipe 140.

Moreover, the sump assembly 200 receives the washing water falling down from the washing chamber after sprayed to the dishes, and supplies the washing water to the spray nozzles again.

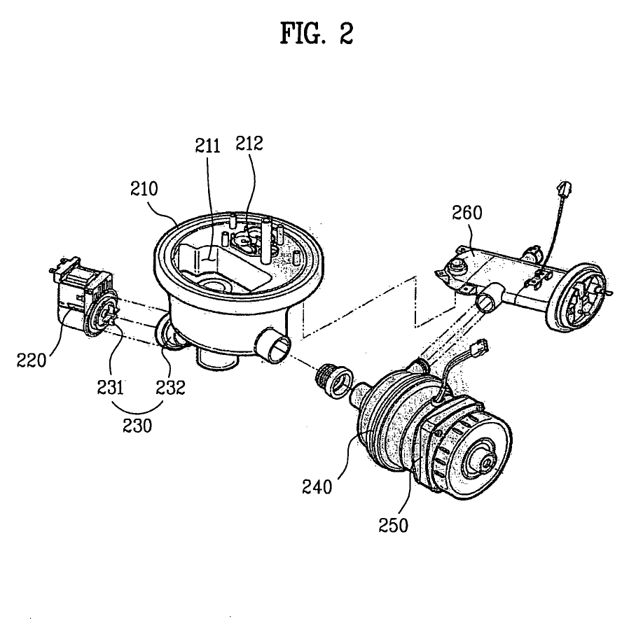

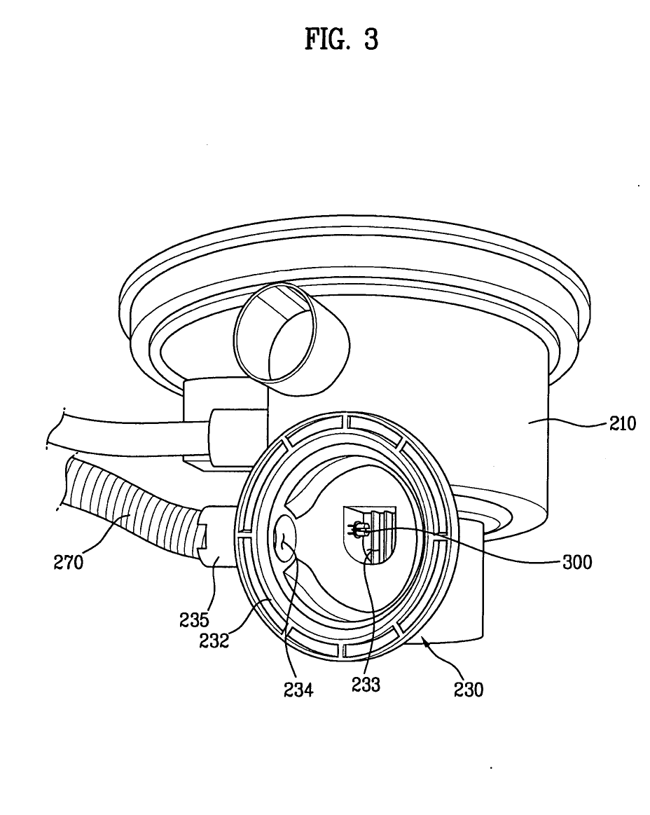

The sump assembly 200 will be described in more detail with reference to FIGS. 2 and 3.

FIG. 2 illustrates a perspective disassembled view of a sum assembly in accordance with a preferred embodiment of the present invention, and FIG. 3 illustrates a perspective view of a drain pump in accordance with a preferred embodiment of the present invention.

Referring to FIGS. 2 and 3, the sump assembly 200 includes a sump 210 for holding the washing water, a washing pump 240, and a drain pump 230.

The sump 210 holds the washing water introduced into the dishwasher from an outside of the dishwasher through a water supply apparatus (not shown), or the washing water falling down from the washing chamber 110 after washing the dishes. For this, the sump 210 has a storage space 211.

On an upper surface of the sump 210, there is a change-over valve 212 for supplying the washing water to the water supply pipe 140 or the lower nozzle 160 selectively, or at the same time, depending on an operation condition of the dishwasher 100.

The washing pump 240 is mounted on one side of the sump 210 for pumping up the washing water to the spray nozzles. For this, the washing pump 240 has a first motor 250 for transmitting a driving force. The washing pump 240 also has a heater 260, for heating the washing water supplied to the spray nozzles, to make the dishwashing more smoothly.

The drain pump 230, mounted on the other side of the sump 230, discharges contaminated washing water to an outside of the dishwasher. For this, the drain pump 230 has a drain hose 270 connected thereto for guiding the washing water to an outside of the dishwasher.

The drain pump 230 has an inlet 233 for receiving the washing water from the sump 210, and an outlet 234 for guiding the washing water to the drain hose 270. Accordingly, the washing water is introduced into the drain pump 230 from the sump 210 through the inlet 233, and guided to the drain hose 270 through the outlet 234.

Thus, the drain pump 230 discharges the washing water heavily contaminated to have a poor washing capability to an outside of the dishwasher, so that fresh washing water can be supplied to the sump 210.

In more detail, the drain pump 230 includes a pump case 232 for holding the washing water from the sump 210, an impeller 231 for pumping the washing water from the pump case 232 to the drain hose 270, and a hose connector 235 for joining with the drain hose 270.

The pump case 232 is mounted on one side of the sump 170, and as described before, has the inlet 233 and the outlet of the drain pump 233. Therefore, the pump case 232 receives the washing water from the sump 210 through the inlet 233, and guides the washing water to the drain hose 270 through the outlet 234.

In rear of the impeller 231, there is a second motor 220 for transmitting driving force to the impeller 231.

In the meantime, inside of the drain pump 230, there is a sensor 300 for measuring a turbidity level of the washing water discharged to an outside of the dishwasher. The sensor 300 measures a turbidity level of the washing water discharged to the outside of the dishwasher through the drain pump 230, and provides to a controller (not shown) of the dishwasher 100. The controller determines progression of the washing according to the turbidity level measured at the sensor 300.

The sensor 300 may be mounted to the inlet 233 of the drain pump. In this instance, the sensor 300 measures a turbidity level of the washing water introduced into the drain pump 230 from the sump 210.

The sensor 300 may be mounted to the outlet 234 of the drain pump. In this case, the sensor 300 measures a turbidity level of the washing water discharged from the drain pump 230 to the drain hose 270. Of course, the sensor 300 may be mounted both to the inlet 233 and the outlet 234 of the drain pump 230 for more accurate measurement of the turbidity level.

In the meantime, the sensor 300 can be mounted on an inside surface of the pump case 230. In this case, the sensor 300, measuring the turbidity level of the washing water at the inside of the pump case 230 where the washing water flows slower than the inlet 230 and the outlet 234, can measure the turbidity level, more accurately.

Moreover, the sensor 300 may be mounted to an inside surface of the hose connector 235. In this case, the sensor 300 measures the turbidity level of the washing water discharged to the outside of the dishwasher through the drain hose 270, finally.

In the meantime, though not shown, the sensor 300 can also be mounted on an inside of the sump 210. In this case, the sensor 300 measures the turbidity level of the washing water circulating inside of the washing chamber 111, and transmits to the controller. According to this, the controller is made to know a level of contamination of the washing water before the washing water is discharged, and to determine the replacement of the washing water earlier.

However, in general, the turbidity level measured by the sensor 300 inside of the sump 210 is not the same with the turbidity level measured by the sensor 300 inside of the drain pump 230.

In more detail, there are many cases when the turbidity level of the washing water measured at the sensor 300 inside of the sump 210 is not accurate. This is because the washing water circulating at a high speed inside of the washing chamber 111 has an unstable flow.

Moreover, since the turbidity level of the washing water is measured in the middle of the dish washing, the turbidity level of the washing water is measured in a state dirt is nor removed from the dishes fully. At the end, the turbidity level measured by the sensor 300 inside of the sump 210, not only is inaccurate, but also has a great variation.

Therefore, it is preferable that the sensor 300 is mounted to an inside of the drain pump 230 for measuring an accurate turbidity level of the washing water. Of course, if it is required to know the turbidity level of the washing water in advance, the sensor 300 may be mounted to an inside of the sump 210. However, in this case too, it is preferable that the sensor 300 is mounted not only to the inside of the sump 210, but also the inside of the drain pump 230.

Thus, a plurality of the sensors 300 may be mounted to various positions, such as the inside of the sump 210 and/or the inside of the drain pump 230 as required.

In the meantime, the sensor 300 is a photocoupler having a light emitting part and a light receiving part. The photocoupler fixes the turbidity level of the washing water according to a quantity of light received at the light receiving part.

The operation of the dishwasher of the present invention will be described.

Upon applying power to the dishwasher 100 after opening the door 112 on the dishwasher 100, and placing the dishes on the upper rack 120, and/of the lower rack 130, the dishwasher is operated.

If the dishwasher operates, the washing water is introduced into the sump 210, and held therein. Once a preset amount of the washing water is introduced into the sump 210, the washing pump 240 is operated by the first motor 250.

The washing pump 240 supplies the washing water from the sump 210 to the lower nozzle 160 and the water supply pipe 140 selectively or at the same time.

The washing water supplied to the lower nozzle 160 is sprayed to the dishes placed on the lower rack 230, and the washing water supplied to the water supply pipe 140 is sprayed to the top nozzle 170, and the upper nozzle 150, and therefrom, to the dishes placed on the upper rack 120.

In more detail, the top nozzle sprays the washing water downward vertically, and the upper nozzle 150 sprays the washing water upward vertically, for washing the dishes on the upper rack 120.

The lower nozzle sprays the washing water upward vertically, for washing the dishes on the lower rack 130. It is preferable that the upper nozzle 150 has spraying holes in an underside surface additionally. In this case, the dishes on the lower rack 130 are washed by the lower nozzle 160 and the upper nozzle 150 at the same time.

Thereafter, the washing water sprayed to the dishes is collected to the sump 210, and supplied to the spray nozzles by the washing pump 240 again. In this instance, the washing water has foreign matters having a relatively large sizes filtered at a filter (not shown) in the sump 210 before being supplied to the spray nozzles.

In the meantime, in the process the foregoing steps are progressed repeatedly, the turbidity level of the washing water is measured by the sensor 300 mounted on the inside of the sump 210 periodically, and transmitted to the controller of the dishwasher 100.

If the turbidity level measured at the sensor 300 exceeds a preset value, the controller puts the drain pump 230 into operation, to discharge the washing water to an outside of the dishwasher 100.

In more detail, if the second motor 220 drives the impeller 231, the washing water held in the sump 210 is introduced into the pump case 230 through the inlet 233 of the drain pump 230. Then, the washing water is guided to the drain hose 270 through the outlet 234 of the drain pump 230, and discharged to an outside of the dishwasher.

In this instance, the turbidity level of the washing water is measured by the sensor 300, once more. That is, as described before, the turbidity level of the washing water is measured by the sensor 300 inside of the drain pump 230, once more.

If it is determined that the dishes are washed adequately as the foregoing process is progressed repeatedly, fresh washing water is supplied to the sump 210 again, and the dishes are processed through a rinsing step.

Upon finishing the rinsing step, a washing process of the dishes is completed through a drying step. In this instance, the proceeding from the washing step to the rinsing step, or from the rinsing step to the drying step is determined according to the turbidity level of the washing water measured by the sensor 300.

That is, the controller (not shown) determines if the washing step is performed more, or if the rinsing step and the drying step to be progressed after the washing step is finished are performed according to the turbidity level measured by the sensor 300.

Thus, the present invention measures the turbidity level of the washing water, not only by the sensor 300 inside of the sump 210, but also by the sensor inside of the drain pump 230. Accordingly, the present invention enables to determine replacement of the washing water and performance of the washing step earlier, and more accurately.

Of course, in a case the sensor 300 is mounted only on an inside of the drain pump 230, the replacement of the washing water and the performance of the washing step are determined with reference to the turbidity level of the washing water discharged from the sump 210.

As has been described, the sump assembly in a dishwasher of the present invention has the following advantages.

First, in the present invention, the controller determines replacement of the washing water and performance of the washing step according to the turbidity of the washing water measured by the sensor. Accordingly, the problems of the waste of washing water, and inadequate washing of the dishes occurred from wrong determination of the user in the related art can be solved.

Second, in the present invention, the sensor inside of the drain pump measures the turbidity level. Accordingly, because the turbidity level of the washing water discharged after dish washing is measured, an accurate turbidity level can be measured.

Third, the present invention can measure the turbidity level of the washing water circulating inside of the washing chamber by mounting the sensors, not only on an inside of the drain pump, but also on an inside of the sump. Accordingly, as the turbidity level of the washing water can be known before discharge of the washing water, replacement of the washing water can be determined earlier.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A sump assembly in a dishwasher comprising:
a sump for holding washing water;
a washing pump on one side of the sump for pumping up the washing water from the sump to spray nozzles;
a drain pump on the other side of the sump for discharging dirty washing water to an outside of the dishwasher;
a drain hose connected to the drain pump for guiding the washing water to the outside of the dishwasher; and
a sensor mounted on an inside of the drain pump for measuring a turbidity level of the washing water discharged to the outside of the dishwasher.

2. The sump assembly as claimed in claim 1, wherein the sensor is provided to an inlet of the drain pump the washing water is introduced therethrough.

3. The sump assembly as claimed in claim 1, wherein the sensor is provided to an outlet of the drain pump the washing water is guided to the drain hose therethrough.

4. The sump assembly as claimed in claim 1, wherein the sensor is provided both to an inlet of the drain pump the washing water is introduced therethrough, and an outlet of the drain pump the washing water is guided to the drain hose therethrough.

5. The sump assembly as claimed in claim 1, wherein the sensor is a photocoupler having a light emitting part and a light receiving part.

6. The sump assembly as claimed in claim 1, wherein the sensor is provided to an inside of the sump additionally, for measuring the turbidity level of the washing water.

7. The sump assembly as claimed in claim 6, wherein the sensor is a photocoupler having a light emitting part and a light receiving part.

8. The sump assembly as claimed in claim 1, wherein the drain pump includes;
a pump case for holding the washing water from the sump,
an impeller for pumping the washing water to the drain hose, and
a hose connector for connection to the drain hose.

9. The sump assembly as claimed in claim 8, wherein the sensor is provided to an inside surface of the pump case.

10. The sump assembly as claimed in claim 8, wherein the sensor is provided to an inside surface of the hose connector.

11. A dishwasher comprising:
a washing chamber for making dish washing therein;
spray nozzles for spraying high pressure washing water to dishes inside of the washing chamber;
a sump for holding washing water;
a washing pump on one side of the sump for pumping up the washing water from the sump to spray nozzles;
a drain pump on the other side of the sump for discharging dirty washing water to an outside of the dishwasher;
a drain hose connected to the drain pump for guiding the washing water to the outside of the dishwasher; and
a sensor mounted on an inside of the drain pump for measuring a turbidity level of the washing water discharged to the outside of the dishwasher.

12. The dishwasher as claimed in claim 11, wherein the sensor is provided to an inlet of the drain pump the washing water is introduced therethrough.

13. The dishwasher as claimed in claim 11, wherein the sensor is provided to an outlet of the drain pump the washing water is guided to the drain hose therethrough.

14. The dishwasher as claimed in claim 11, wherein the sensor is provided both to an inlet of the drain pump the washing water is introduced therethrough, and an outlet of the drain pump the washing water is guided to the drain hose therethrough.

15. The dishwasher as claimed in claim 11, wherein the sensor is a photocoupler having a light emitting part and a light receiving part.

16. The dishwasher as claimed in claim 11, wherein the sensor is provided to an inside of the sump additionally, for measuring the turbidity level of the washing water.

17. The dishwasher as claimed in claim 16, wherein the sensor is a photocoupler having a light emitting part and a light receiving part.

18. The dishwasher as claimed in claim 11, wherein the drain pump includes;
a pump case for holding the washing water from the sump,
an impeller for pumping the washing water to the drain hose, and
a hose connector for connection to the drain hose.

19. The dishwasher as claimed in claim 18, wherein the sensor is provided to an inside surface of the pump case.

20. The dishwasher as claimed in claim 18, wherein the sensor is provided to an inside surface of the hose connector.
